(19) United States
(12) Patent Application Publication
(10) Pub. No.: US 2016/0102828 A1
(43) Pub. Date: Apr. 14, 2016

(54) LAMP FOR VEHICLE

(71) Applicant: HYUNDAI MOTOR COMPANY, Seoul (KR)

(72) Inventor: Byoung Suk AHN, Suwon-si (KR)

(21) Appl. No.: 14/609,309

(22) Filed: Jan. 29, 2015

(30) Foreign Application Priority Data
Oct. 14, 2014 (KR) 10-2014-0138473

(51) Int. Cl. F21S 8/10

(52) U.S. Cl. CPC F21S 48/13; F21S 48/1225; F21S 48/1145

(57) ABSTRACT

A lamp for a vehicle includes a light source producing light and a reflector receiving light from the light source and making energy density per unit area of a portion of the exiting light different from that of the incident light.

### CROSS REFERENCE TO RELATED APPLICATION

The present application claims priority to Korean Patent Application No. 10-2014-0138473, filed Oct. 14, 2014, the entire contents of which is incorporated herein for all purposes by this reference.

### BACKGROUND OF THE INVENTION

1. Field of the Invention

Embodiments of the present invention generally relate to a lamp for a vehicle, and more particularly, to a lamp for a vehicle using a laser as a light source without leakage of light due to damage to a fluorescent member.

2. Description of the Related Art

Vehicles are equipped with various kinds of lamps in accordance with their use and positions, and light sources suitable for the features of the lamps are used.

For example, a halogen bulb and an LED (light-emitting diode) may be used as the light source of headlamps. Recently, research of using a laser as a light source has been conducted.

A lamp using a laser uses light, which is produced when a laser is radiated onto a fluorescent member, as a light source and has a structure using the feature that white light or yellow light is produced by mixing the wavelength of a laser and the wavelength produced by a fluorescent member when a laser is radiated.

However, according to the lamp using a laser, a laser is radiated directly onto a fluorescent member, so the fluorescent member may be damaged, and when light is not produced by the fluorescent member, the laser may leak and travel directly to the outside. Therefore, there is a danger of seriously injuring drivers in other vehicles.

The foregoing is intended merely to aid in the understanding of the background of the present invention, and is not intended to mean that the present invention falls within the purview of the related art that is already known to those skilled in the art.

### SUMMARY OF THE INVENTION

Accordingly, the present invention has been made keeping in mind the above problems occurring in the related art, and the present invention is intended to propose a lamp for a vehicle which prevents a laser from directly traveling to the outside, even if the laser leaks due to damage or a loss of function of a fluorescent member.

In order to achieve the above object, according to one aspect of the present invention, there is provided a lamp for a vehicle which includes: a light source producing light; and a reflector receiving light from the light source and making energy density per unit area of a portion of the exiting light different from that of the incident light.

The lamp may further include a hole formed at a position of the reflector to which light travels in order to receive a portion of the light that travels to the reflector.

A fluorescent member receiving incident light and outputting light having a wavelength different from that of the light from the light source may be disposed between the light source and the reflector.

A filter reflecting light from the fluorescent member and transmitting light from the light source may be disposed in the hole.

A diffuser transmitting a portion of the light from the light source and reflecting and diffusing the rest of the light may be inserted in the hole.

A filter reflecting light from the fluorescent member and transmitting light from the light source may be disposed at the inlet of the hole.

A minute pattern may be formed at a position, to which light from the light source travels, on a surface of the reflector in order to disperse the light.

The light source may produce a laser beam.

The hole may be formed at a position, to which a laser beam travels, on the reflector to receive the laser beam.

According to another aspect of the present invention, there is provided a lamp for a vehicle which may a light source emitting light along an optical path and a reflector including a first portion intersected by the optical path and a second portion surrounding the first portion. Reflectance of the first portion may be less than reflectance of the second portion.

The lamp for a vehicle may include a fluorescent member disposed on the light source. The fluorescent member may receive the light emitted by the light source and output light having a wavelength different from that of the light emitted by the light source.

The light emitted by the light source may be a laser beam.

The reflector may include a hole formed at the first portion of the reflector.

The lamp for a vehicle may include a filter disposed at the hole. The filter may reflect and transmit light from the fluorescent member.

The lamp for a vehicle may include a diffuser inserted in the hole. The diffuser may transmit a portion of light from the light source and reflect and diffuse the rest of the light.

The lamp for a vehicle may include a minute pattern formed on a surface of the first portion of the reflector.

According to the lamp for a vehicle having the structure described above, light cannot be radiated directly to the outside, even if light leaks due to damage and a loss of function of the fluorescent member, so passengers in other vehicle may avoid directly seeing the reflected laser beam with relatively high light intensity.

Further, even if light leaks, the light is partially diffused, so it is possible to keep the field of vision even if the fluorescent member is damaged.

### BRIEF DESCRIPTION OF THE DRAWINGS

The above and other objects, features and other advantages of the present invention will be more clearly understood from the following detailed description when taken in conjunction with the accompanying drawings, in which:

FIGS. 1A and 1B are views showing the configuration of a lamp for a vehicle according to a first embodiment of the present invention;

FIGS. 2A and 2B are views showing the configuration of a lamp for a vehicle according to a second embodiment of the present invention;

FIGS. 3A and 3B are views showing the configuration of a lamp for a vehicle according to a third embodiment of the present invention;

FIGS. 4A and 4B are views showing the configuration of a lamp for a vehicle according to a fourth embodiment of the present invention; and

FIGS. 5A and 5B are views showing the configuration of a lamp for a vehicle according to a fifth embodiment of the present invention.

### DETAILED DESCRIPTION OF THE INVENTION

Hereinbelow, lamps for a vehicle according to exemplary embodiments of the present invention will be described with reference to the accompanying drawings.

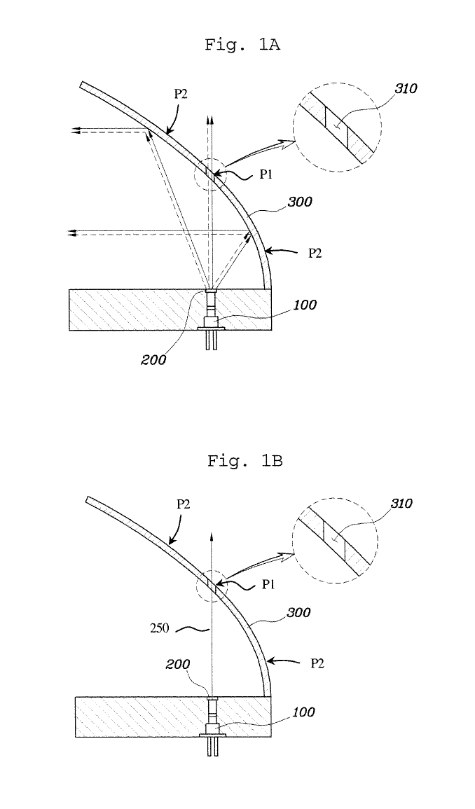

Lamps for a vehicle according to first to fifth embodiments, illustrated in FIGS. 1A through 5B, of the present invention may include a light source 100 that produces light, and a reflector 300 that receives light from the light source 100 and makes energy density per unit area of a portion of the exiting light different from that of incident light.

The light source 100 may be a laser diode producing a laser beam. However, the present invention is not limited to a laser diode, and a light emitting device producing a straight beam, similar to a laser, or a device using an LED may alternatively be used. Thus, more various types of light emitting devices may be used as the light source. The light, which may be a laser beam, straight beam, narrow beam etc., emitted by the light source 100 travels along an optical path 250, if no fluorescent member or a damaged fluorescent member is disposed at the optical path 250.

A fluorescent member 200, which keeps incident light and outputs light having a wavelength different from the light from that of the light source 100, may be further provided between the light source 100 and the reflector 300. The fluorescent member 200 may be modularized with the light source 100 or may be supported by a specific structure. The fluorescent member 200 may diffuse and/or scatter the emitted light by the light source 100. Thus, the light output from the fluorescent member 200 may not only travel along the optical path 250 but also be expanded with respect to the optical path 250. In other words, the fluorescent member 200 may modulate the wavelength of the light emitted by the light source 100 and also expand the path along which the light emitted by the light source 100 travels.

FIGS. 1A and 1B are views showing the configuration of a lamp for a vehicle according to a first embodiment of the present invention, in which FIG. 1A shows a normal state and FIG. 1B shows a damaged state. The normal state refers to a state when the fluorescent member 200 is not damaged or moved, and transmits light emitted by the light source 100 to the reflector 300. The damaged state refers to a state when the fluorescent member 200 is damaged or moved from its original position with respect to the light source 100 and thus may not functionally transmit light emitted by the light source 100 to the reflector 300. In the damaged state, the light emitted by the light source 100 may only travel along the optical path 250, or a majority of the light emitted by the light source 100 travels along the optical path 250, or light density of the light that travels along the optical path 250 increases due to damage or movement of the fluorescent member 200. As shown in the figures, the lamp for a vehicle according to the first embodiment may further include a hole 310 formed at the position of the reflector 300 to which light travels when the fluorescent member 200 is damaged or moved with respect to the light source 100, to receive a portion of the light traveling to the reflector 300.

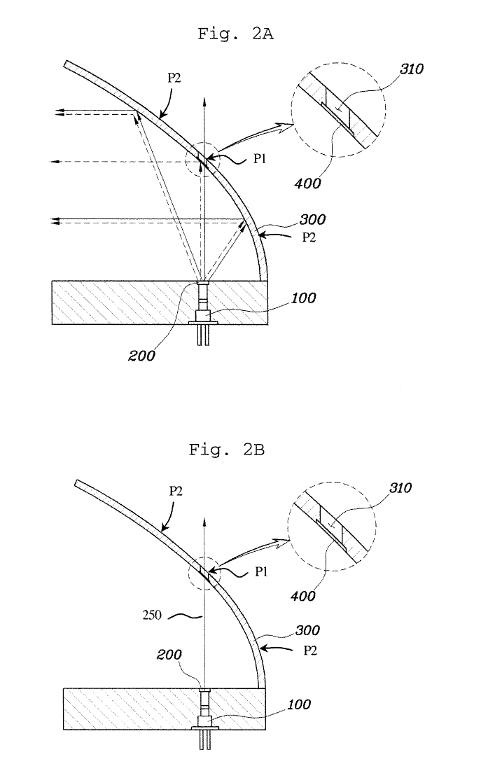

The hole 310 may be penetrating through the reflector 300, and as shown in FIG. 1B, it may be formed at the incident position of the laser beam on the reflector 300 to receive the laser beam. That is, when a laser beam 100 is emitted vertically upward from the light source 100, the hole 310 may be formed in the path of the laser beam so that the laser beam can pass through the reflector 300. The path of the laser beam refers to an optical path along which the laser beam emitted by the light source 100 travels, when the fluorescent member 200 is damaged or moved with respect to the light source 100. In this case, the hole 310 intersects the path of the laser beam, i.e., the optical path 250 shown in FIG. 2. Accordingly, reflectance of a first portion P1 of the reflector 300 is less than reflectance of a second portion P2, which surrounds the first portion P1, of the reflector 300, due to the formation of the hole 310 at the first portion P1.

Since the hole 310 is formed in the path of a laser beam, even if the fluorescent member 200 is damaged or moved from the initial position by a collision of a vehicle or an unexpected shock and consequently a laser beam from the light source 100 leaks, the laser beam travels to the outside through the reflector 300 without being reflected by the reflector 300. Accordingly, it is possible to preclude a human accident due to a laser beam radiated to the outside.

However, in the normal state, as shown in FIG. 1A, most of light from the fluorescent member 200 is reflected by the reflector 300 and only the light traveling to the hole 310 goes out of the reflector 300. Accordingly, there is a loss of energy of the light from the light source 100 at the hole 310 and the energy density per unit area of the light traveling to the hole 310 is different when the light enters and goes out of the hole.

FIGS. 2A and 2B are views showing the configuration of a lamp for a vehicle according to a second embodiment of the present invention, in which FIG. 2A shows a normal state and FIG. 2B shows a damaged state.

The basic configuration is similar to that shown in FIGS. 1A and 1B, but a filter 400 that reflects light from the fluorescent member 200 and transmits the light from the light source 100 may be further provided in the hole 310.

The filter may transmit shorter-wavelength light such as a laser beam and reflects longer-wavelength light such as the light produced by the fluorescent member 200, as shown in FIG. 2A. Accordingly, it is possible to prevent light produced by the fluorescent member 200 from being dissipated through the hole 310 in a normal state, so energy efficiency can be increased. On the other side, the laser beam passing through the fluorescent member 200 may pass through the hole 310, as in the first embodiment, and as shown in FIG. 2B, even if the fluorescent member 200 breaks and a laser beam leaks outside, the laser beam goes out of the reflector 300 through the filter 400.

Therefore, as compared with the first embodiment, it is possible to lower the difference in energy density per unit area when light enters and goes out of the hole 310 and to prevent a danger of leakage of a laser beam.

The filter 400 may be disposed at any position in the hole 310, but it may be disposed at the inlet of the hole in parallel with the surface of the reflector 300 to increase efficiency of reflection.

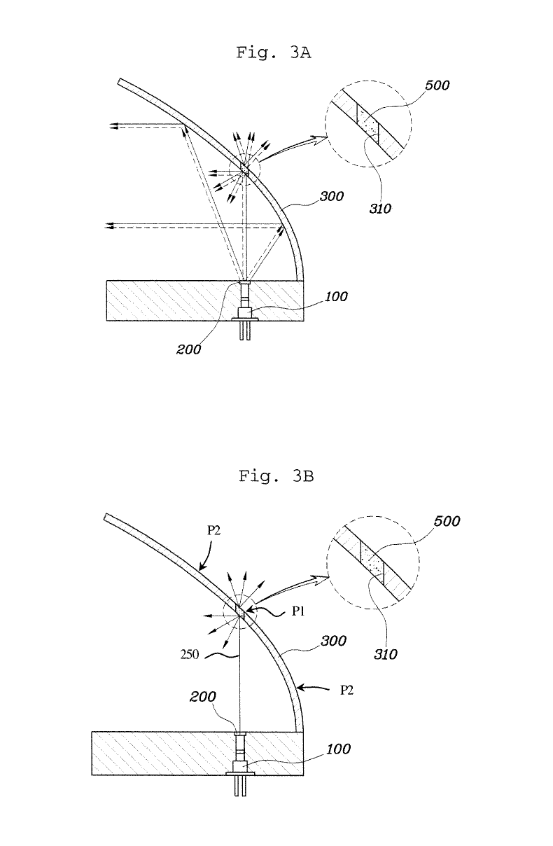

FIGS. 3A and 3B are views showing the configuration of a lamp for a vehicle according to a third embodiment of the present invention, in which FIG. 3A shows a normal state and FIG. 3B shows a damaged state.

As shown in the figures, a diffuser 500 that transmits a portion of light traveling to the reflector 300 and reflects and diffuses the rest of the light may be inserted in the hole 310.

The diffuser may be made of various materials, and for example, acrylic resin may be used and materials containing glass and metal may be used.

The diffuser 500, as shown in FIGS. 3A and 3B, reflects a portion of the laser beam and the light from the fluorescent member 200 and transmits a portion thereof, so it generates a difference in energy density of light when the light enters and goes out of the diffuser 500. Further, even if some of the laser beam may be reflected the diffuser 500, due to diffuse reflection caused by the diffuser 500, the energy density per unit area decreases and the danger associated therewith can decrease.

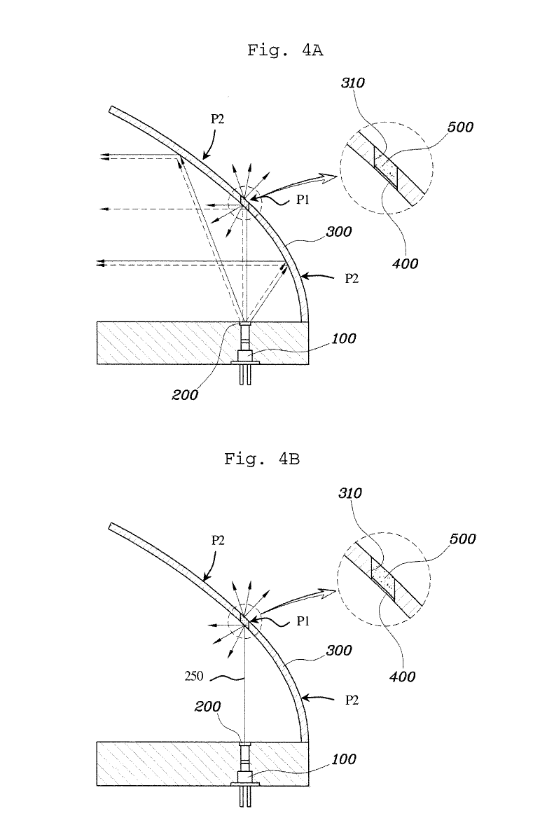

FIGS. 4A and 4B are views showing the configuration of a lamp for a vehicle according to a fourth embodiment of the present invention, in which FIG. 4A shows a normal state and FIG. 4B shows a damaged state.

The fourth embodiment includes the filter 400 of the second embodiment and the diffuser 500 of the third embodiment, in which the diffuser 500 is inserted in the hole 310 and the filter 400 is disposed at the inlet of the hole 310.

Accordingly, in a normal state, light from the fluorescent member 200 can reflect forward from the filter 400 without a loss and a portion of the laser beam reflects forward from the diffuser 500 and the rest can go out of the reflector 300 through the diffuser 500.

According to this configuration, it is possible to lower the difference in energy density of light when the light enters and goes out of the hole 310. Further, efficiency of light from the light source 100 increases and safety against leakage of a laser beam can be ensured.

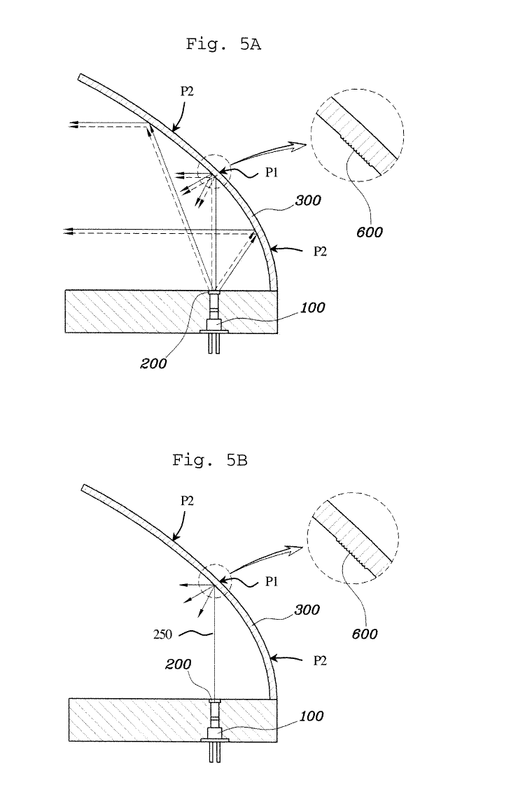

FIGS. 5A and 5B are views showing the configuration of a lamp for a vehicle according to a fifth embodiment of the present invention, in which FIG. 5A shows a normal state and FIG. 5B shows a damaged state.

A minute pattern 600 may be formed on the surface, to which light from the light source travels, of the reflector 300 in order to disperse the light.

The minute pattern 600 may be formed at the position where the hole 310 is formed, and may be formed on the surface of the reflector 300 without the hole 310. As another embodiment, the hole 310 may be formed and a panel with the minute pattern 600, similar to the filter 400, may be disposed in the hole 310.

The minute pattern 600 may be composed of a plurality of minute projections and the shape of the pattern is not limited to a specific shape.

Further, the shape of the pattern and the number of the minute projections may be set such that the energy density per unit area of a laser beam reflecting from the fine pattern 600 is lower than the energy density per unit area of a laser beam traveling to the minute pattern 600.

Even if the lamp breaks, a laser beam is diffused by the minute pattern 600 and the energy density per unit area decreases, so danger of a laser beam can be reduced.

According to the lamps for a vehicle having the structures described above, light cannot be radiated directly to the outside, even if light leaks due to damage and a loss of function of the fluorescent member, so passengers in other vehicle may avoid directly seeing the reflected laser beam with relatively high light intensity.

Further, even if light leaks, the light is partially diffused, so it is possible to maintain the field of vision even if the fluorescent member is damaged.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A lamp for a vehicle, comprising:
a light source producing light; and
a reflector receiving light from the light source and making energy density per unit area of a portion of exiting light different from that of incident light.

2. The lamp of claim 1, further comprising a hole formed in the reflector at a position to which light travels and receiving a portion of the light that travels to the reflector.

3. The lamp of claim 2, comprising a fluorescent member disposed between the light source and the reflector, the fluorescent member receiving incident light and outputting light having a wavelength different from that of the light from the light source.

4. The lamp of claim 3, comprising a filter disposed at the hole, the filter reflecting light from the fluorescent member and transmitting light from the light source.

5. The lamp of claim 3, comprising a diffuser inserted in the hole, the diffuser transmitting a portion of light from the light source and reflecting and diffusing the rest of the light.

6. The lamp of claim 5, comprising a filter disposed at the inlet of the hole, the filter reflecting light from the fluorescent member and transmitting light from the light source.

7. The lamp of claim 1, comprising a minute pattern formed at a position, to which light from the light source travels, on a surface of the reflector and dispersing the light.

8. The lamp of claim 1, wherein the light source produces a laser beam.

9. The lamp of claim 8, wherein a hole is formed in the reflector at a position, to which a laser beam travels.

10. A lamp for a vehicle, comprising:
a light source emitting light along an optical path;
a reflector including a first portion intersected by the optical path and a second portion surrounding the first portion, reflectance of the first portion being less than reflectance of the second portion.

11. The lamp of claim 10, comprising a fluorescent member disposed on the light source,
wherein the fluorescent member receives the light emitted by the light source and outputs light having a wavelength different from that of the light emitted by the light source.

12. The lamp of claim 10, wherein the light emitted by the light source is a laser beam.

13. The lamp of claim 10, wherein the reflector includes a hole formed at the first portion of the reflector.

14. The lamp of claim 13, comprising a filter disposed at the hole, the filter reflecting and transmitting light from the fluorescent member.

15. The lamp of claim 13, comprising a diffuser inserted in the hole, the diffuser transmitting a portion of light from the light source and reflecting and diffusing the rest of the light.

16. The lamp of claim 10, comprising a minute pattern formed on a surface of the first portion of the reflector.
